(19) United States
(12) Patent Application Publication
(10) Pub. No.: US 2003/0150216 A1
(43) Pub. Date: Aug. 14, 2003

(54) Gas turbine

(76) Inventors: John Timothy O'Beck, Tulsa, OK (US); Rex Carl Tendick, Tulsa, OK (US)

Correspondence Address: John E. Vick, Jr., Dority & Manning, Attorneys at Law, P.A., P.O. Box 1449, Greenville, SC, 29602, US

(21) Appl. No.: 10/180,212

(22) Filed: Jun. 26, 2002

Related U.S. Application Data
(60) Provisional application No. 60/303,164, filed on Jul. 3, 2001.

(51) Int. Cl. F02C 3/30

(52) U.S. Cl. 60/775; 60/776; 60/746

(57) ABSTRACT

A gas turbine is provided that includes combustor configured to burn a low-heating-value fuel and further configured to receive steam that is injected into the gas turbine. A method of modifying a gas turbine and for operating a gas turbine are presented.

### CROSS REFERENCE TO RELATED APPLICATIONS

This application claims priority to pending provisional U.S. Application No. 60/303,164 filed Jul. 3, 2001.

### TECHNICAL FIELD OF THE INVENTION

The present invention relates to gas turbines and more particularly to a gas turbine and method that use a low-heating-value fuel and steam injection.

### BACKGROUND OF THE INVENTION

The typical, commercial gas turbine is designed for use with a fuel gas that is combusted in a combustor. The combustor drives an expander or expansion section from which useful work is obtained. The heating value of such a fuel gas is typically on the order of about 50,000 to 60,000 kJ/kg. In certain applications, it is desirable to operate the gas turbine on a low-heating-value fuel.

Specialized combustors have been proposed for burning low-heating-value fuels. A notable example is provided in U.S. Pat. No. 6,201,029 B1 to Waycuilis. An example of this technology is presented with reference to FIGS. 1-2.

The combustor 10 described herein for purposes of illustration includes a casing 12, termed the “combustor can”, and a combustion liner 14. The combustor can 12 is cylindrically configured with a substantially open upstream end 16 and a dome-shaped, substantially closed downstream end 18. Conversely, the combustion liner 14 is cylindrically configured with a substantially open downstream end 20 and a dome-shaped, substantially closed upstream end 22. The combustion liner 14 is concentrically positioned within the combustor can 12 and has a substantially smaller diameter than the combustor can 12 to define a mixing annulus 24 between the combustor can 12 and the combustion liner 14 which opens into the upstream end 16 of the combustor can 12. As related to the combustor 10, the terms “downstream” and “upstream” are used herein with reference to the flow direction of the gaseous flame zone and combustion products within the combustor 10.

Referring additionally to FIG. 2, the combustion liner 14 is constructed from a plurality of sequentially overlapping segments 26. The downstream end 28 of each segment 26 is nested within the upstream end 30 of the succeeding segment 26 to form a sequence of annular cooling spaces 32 around the circumference of the combustion liner 14. A plurality of cooling perforations 34 are also provided in substantially the entire outer surface of the combustion liner 14.

A plurality of LHV fuel gas injectors 36, typically numbering from 4 to 12, are radially disposed around the circumference of the combustor can 12 proximal to the upstream end 16 of the combustor can 12. The LHV fuel gas injectors 36 may broadly encompass any type of opening through the combustor can 12 or any injection device directed through the combustor can 12. An LHV fuel gas burner line 38 and a high-heating-value (HHV) fuel gas burner line 40 are positioned external to the combustor can 12 and join at a junction point 42 to form a burner feed line 44 carrying a burner fuel gas which passes through the downstream end 18 of the combustor can 12.

The combustor 10 further includes a burner assembly 46 positioned at the upstream end 22 of the combustion liner 14. The burner assembly 46 has a plurality of external burner ports 48 in fluid communication with the mixing annulus 24. The burner assembly 46 also has a central burner port 50 and a central burner nozzle 52, which concentrically penetrates the central burner port 50. Fixed swirling vanes 54 are positioned in the central burner port 50 surrounding the central burner nozzle 52. The central burner port 50 and central burner nozzle 52 discharge into the open interior of the combustion liner 14, which defines a combustion chamber 56. The central burner port 50 and central burner nozzle 52 are in fluid isolation with respect to one another such that fluids in the central burner nozzle 52 do not substantially commingle with fluids in the central burner port 50 until the fluids have exited the central burner nozzle 52 and central burner port 50, respectively, into the combustion chamber 56.

The combustion chamber 56 comprises a plurality of stages or zones including a flame zone 58 proximal to the upstream end 22 of the combustion liner 14 at the discharge of the central burner port 50 and central burner nozzle 52 and an oxidation zone 60 downstream of the flame zone 58 proximal to the downstream end 20 of the combustion liner 14. A plurality of primary combustion chamber ports 62 and secondary combustion chamber ports 64 are radially disposed around the circumference of the combustion liner 14 downstream of the LHV fuel gas injectors 36. The primary and secondary combustion chamber ports 62, 64 enter the combustion chamber 56 approximately between the flame zone 58 and the oxidation zone 60, providing fluid communication between the mixing annulus 24 and the combustion chamber 56. The region of the mixing annulus 24 positioned between the LHV fuel gas injectors 36 and the primary combustion chamber ports 62 is termed the high velocity-mixing zone 66.

The combustor 10 is preferably fabricated from a conventional external can combustor. In particular, the combustor 10 is preferably fabricated by retrofitting a conventional external can combustor with an LHV fuel gas burner line 38, LHV fuel gas injectors 36, and any additional elements taught herein, as required. Combustors having utility in the present combustion process may likewise be fabricated by retrofitting one of the various types of conventional internal combustors in a similar manner, as is apparent to the skilled artisan. Thus, conventional equipment is readily adapted at a relatively low cost enabling practice of the present combustion process. The resulting combustor is a high temperature vessel typically operable within a sustained temperature range of about 1000 to 2000.degree. C., and a sustained pressure range of about 800 to 1,100 kPa.

The exhaust gas of a gas turbine is at a high-energy state, and without doing more, is wasted. To enhance performance of gas turbines, heat recovery steam generators were added to capture energy in the exhaust by converting it to steam. The steam was sent to a separate steam turbine where it was converted to useful work. One enhancement on this approach is to use the steam directly in the gas turbine. The need for a separate steam turbine is avoided and thus capital expense and size are decreased. With this approach, a significant increase in power output can be obtained over the straight gas turbine-more than 50% in many instances. This approach was proposed starting at least as early as the 1970s.

For example, in U.S. Pat. No. 3,978,662 to Cheng, a heat engine was presented that provided work output from a first working fluid operating in essentially a Brayton-type thermodynamic cycle and from a second working fluid operating essentially in a Rankine-type thermodynamic cycle. The two working fluids interacted with each other so that the work output of the two working fluids, working in parallel during the conversion of heat energy to work, was compounded. This type of technology has been referred to by some as a Cheng Cycle. Another example is presented with reference to FIG. 3 and is based on U.S. Pat. No. 5,170,622 to Cheng.

A system 70 incorporating a basic Cheng cycle includes a gas turbine 72 with a compressor section 74, a combustor 76, and an expander or expansion section 78. The compressor 74 is linked by shaft 80 to expander 78. The expander 78 drives compressor 74 and drives a load 82, such as a generator.

The compressor receives air 84, compresses it, and discharges the compressed air 86 to the combustor 76. Fuel is introduced through line 88 to the combustor 76. Steam delivered by line 90 is introduced into a portion of the combustor 76. Heat recovery steam generator (HRSG) unit 96 develops the steam 90. The combusted air and steam are mixed and reaches a predetermined turbine inlet temperature, and then the mixture is discharged at 92 through expander or turbine 78. The exhaust gas exits the expander 78 at 94.

The exhaust gas 94 then passes through the heat recovery steam generator HRSG 96, which is divided into two parts, a superheater 98, and a water-to-steam generator or unit evaporator 100. The hot exhaust gas enters the superheater 98 gives up the heat to superheat the steam entering at 102 and exiting to line 90. A duct burning capability is not depicted here, but is normally located at 104. The remainder of the heat is recovered by the unit evaporator 100 and the remainder of the exhaust gas exits at 106. The exhaust gas 106 has the option of going through a cleanup or condensing unit 108, then to the atmosphere through exhaust 110. Water can be recovered through 108 or can be totally used as a makeup entering or mixing with a separate make up water port 112.

Water in line 114 is compressed to a high pressure through a pump 116. The pump outlet delivers the water by line 118 into the HRSG 96. The evaporator 100 controls the steam flow by valve 120, which delivers to the superheater 98, or valve 122, which delivers to a steam user as a cogeneration unit. If used for power generation only, 122 is not needed. Additional valves can be added to enhance control. See, e.g., U.S. Pat. No. 5,170,622.

### SUMMARY OF THE INVENTION

According to an aspect of the present invention, a gas turbine is provided that includes combustor configured to burn a low-heating-value fuel and further configured to receive steam that is injected into the gas turbine. According to other aspects of the present invention, a method of modifying a gas turbine and for operating a gas turbine are presented.

The present invention provides advantages; a number of examples follow. An advantage of the present invention is that a standard combustor can be modified to arrive at a suitable combustor for use with a low-heating-value fuel. Another advantages of the present invention is that while the low-heating-value fuel would normally result in a significant decrease in output power, the inclusion of steam injection allows the turbine to approach its initial rated output. Another advantage of the present invention is that a hydrocarbon conversion system (such as Fischer-Tropsch-based system) can use the invention to provide compressed air, burn a low-heating-value tail gas, dispose of contaminated water, and regulate the gas turbine's output notwithstanding fluctuations in tail gas output.

### BRIEF DESCRIPTION OF THE DRAWINGS

For a more complete understanding of the present invention and advantages thereof, reference is now made to the following description taken in conjunction with the accompanying drawings in which like reference numbers indicate like features, and wherein:

FIG. 1 is a perspective view of a combustor of a prior art combustor system;

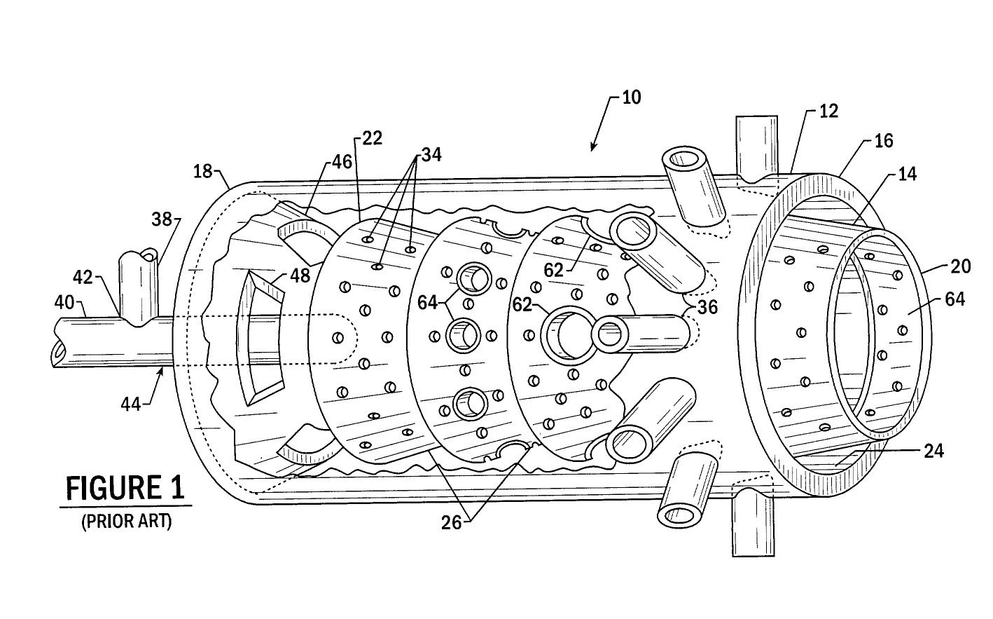

FIG. 2 is a cross-section view of the combustor of FIG. 1;

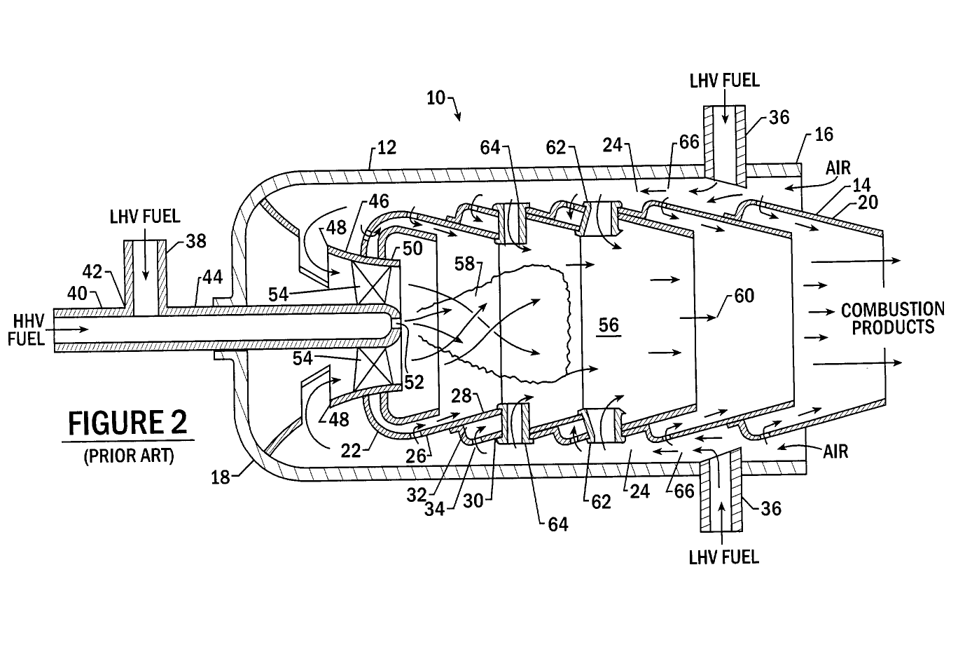

FIG. 3 is a schematic diagram of a prior art system showing a Cheng cycle;

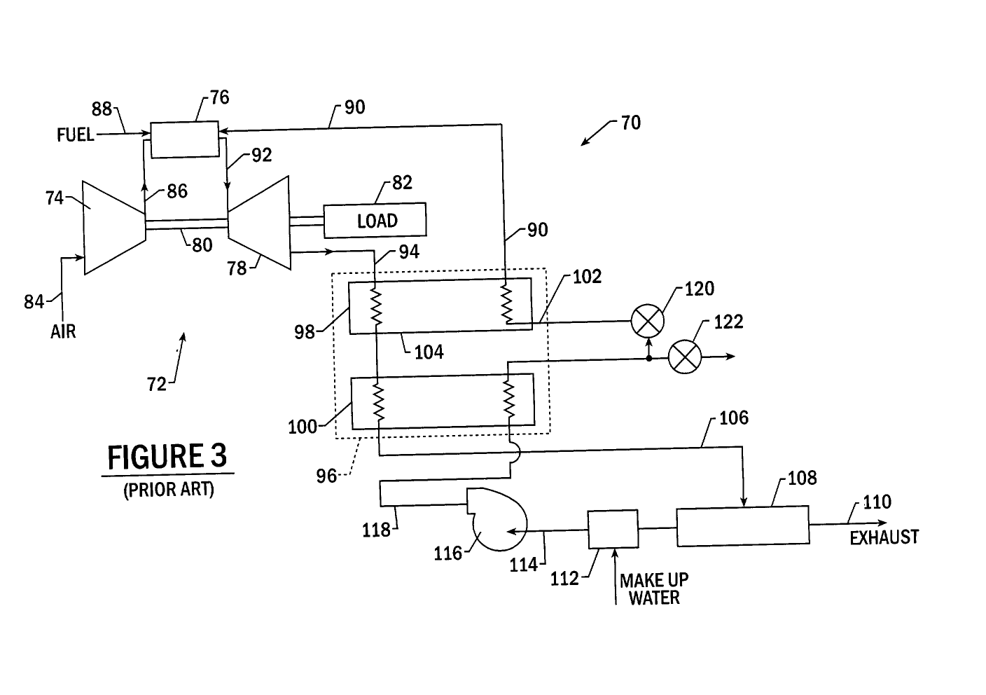

FIG. 4 is a schematic diagram of a gas turbine according to an aspect of the present invention; and

FIG. 5 is a schematic diagram of a combustor according to an aspect of the present invention.

### DETAILED DESCRIPTION OF THE INVENTION

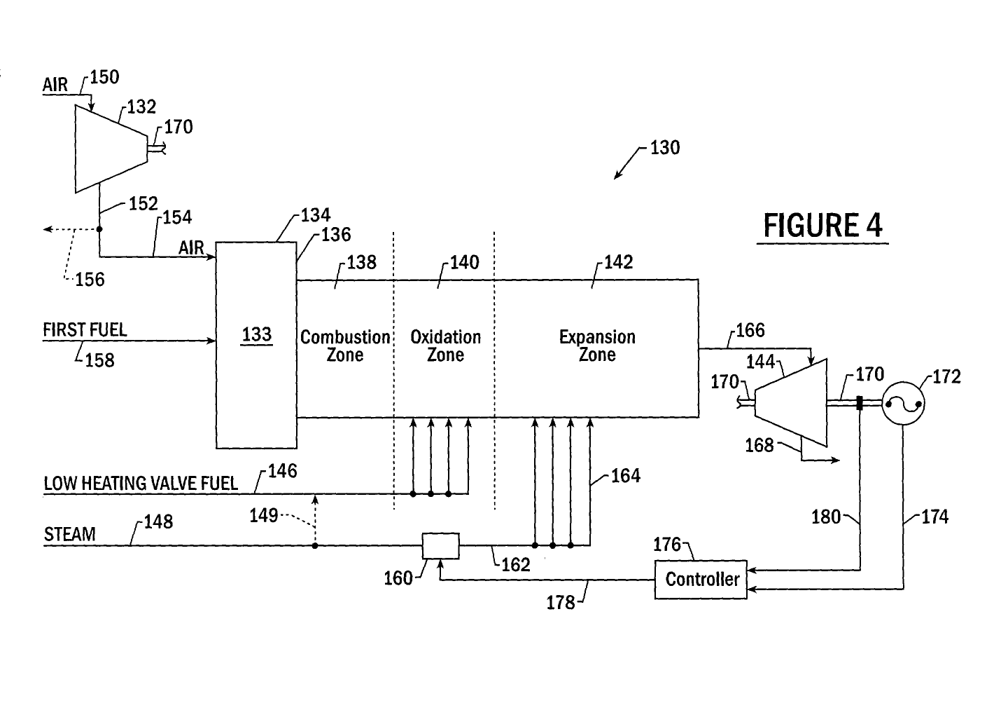

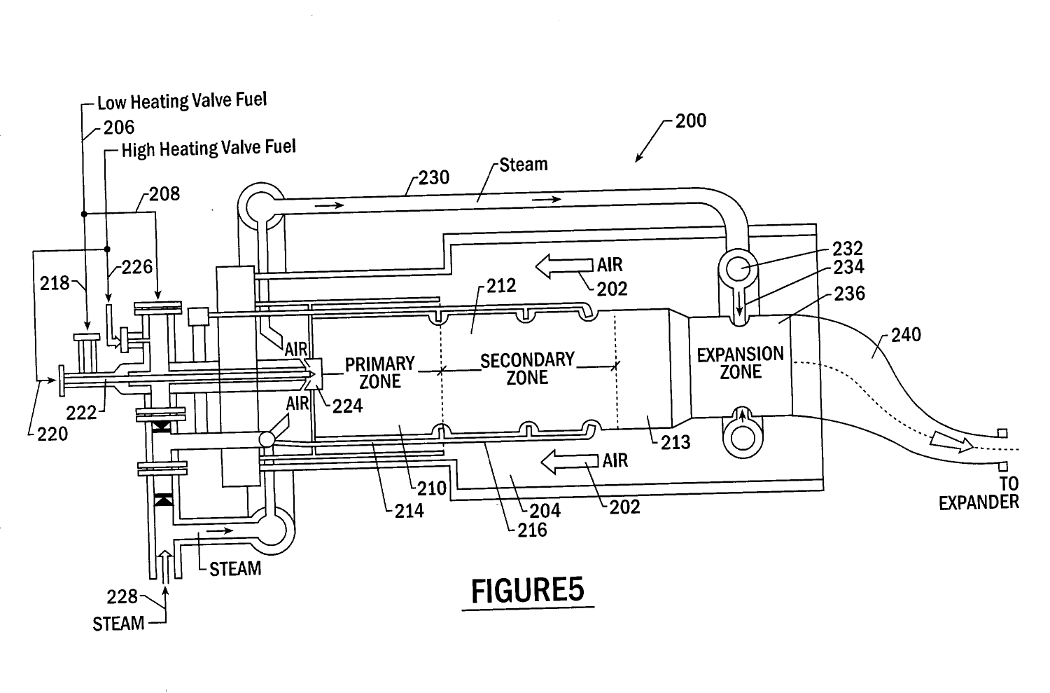

The preferred embodiment of the present invention and its advantages are best understood by referring to FIGS. 4-5 of the drawings, like numerals being used for like and corresponding parts of the various drawings.

Referring to FIG. 4, one embodiment of a gas turbine 130 according to the present invention is presented. Gas turbine 130 includes a compressor 132; a combustor 134, which has a preparation zone 136, a flame zone or combustion zone 138, an oxidation zone 140, and an expansion zone 142; and a turbine or expander 144. As an important aspect of the present invention, the combustor 134 includes multiple zones designed and configured to burn a low-heating-value fuel provided through conduit 146 and is designed and configured to receive large quantities of steam delivered to conduit 148. The mass flow increase from the large quantities of steam may account for an increase of 40-70% and may increase power output by more than 50%. The combustor 34 is figurative and only shows a portion of the combustor.

Air is delivered through conduit 150 to compressor 132, where it is compressed and delivered to conduit 152. The air delivered to conduit 152 may be delivered completely through conduit 154 to combustor 134 or a portion may be extracted as suggested by conduit 156 for other uses such as process air for a hydrocarbon conversion plant. A head 133 (which may include preparation zone 136) of the combustor can may have radial burners and the like in it.

The air in conduit 154 is delivered to combustor 134 along with a first fuel 158. The first fuel 158 can be a high-heating-value fuel, e.g., methane, or a blend that includes a low-heating-value fuel to form a medium heating value fuel, e.g., a 150-300 BTU/scf fuel. The mixing/preparation zone 136, combustion zone 138, and oxidation zone 140 cooperate with a low-heating-value fuel delivered through conduit 146 to allow the combustor to use an extremely low heating-value fuel such as one less than 150 Btu/scf and even as low as 40 Btu/scf.

The inclusion of a steam system along with a low-heating-value burner is an important aspect of the present invention. The steam is delivered to conduit 148, which delivers it to a control valve 160. The steam in line 148 can also be provided in part to the low-heating-value fuel stream as suggested by line 149. The steam in line 148 can be from many sources; for example, it can be from a boiler, a heat recovery steam generator system attached to receive exhaust gases from outlet 168 or from the process to which extraction line 156 is coupled or any other sources of steam. From control valve 160, the steam is delivered through conduit 162 to a plurality of injectors 164. Injectors 164 deliver a substantial amount mass to the exhaust stream that exits the combustor through conduit 166. The exhaust stream is then delivered to expander 144 where it is expanded and then exhausted through outlet 168. Since the expander 144 receives a mixture of steam and combustion products, the internal blades may be optimized by combining features of steam turbines and gas turbine expanders.

The expansion within expander 144 drives shaft 170 that turns compressor 132 and carries a load such a generator 172. The load developed by shaft 170 may be measured with an appropriate transducer and a signal provided by signal line 174 to controller unit 176. If controller 176 is to control the load developed at 172 to be constant, the signal of line 174 is monitored by the controller 176 and it then produces a control signal that is delivered by control line 178 to control valve 160 that regulates the steam flow through it. The flow regulation is maintained in a way that maintains a constant load at 172 if that is desired. Alternatively, the speed of shaft 170 may be monitored and a speed-monitoring signal may be provided by line 180 to the controller 176. Controller 176 can then adjust with a control signal delivered by line 178 to the control valve 160 to maintain a constant speed if that is the desired result.

Referring now to FIG. 5, a portion of a turbine 200, which features primarily the combustor portion, according to an aspect of the present invention is presented. Compressed air 202 from a compressor is delivered and is provided to a mixing zone or annulus 204. A low-heating-value fuel is delivered by line 206. The low-heating-value fuel line is divided between two portions: a first portion 208 and a second portion 218. The first portion 208 is delivered primarily to a flame zone or combustion chamber 210 and to a secondary zone or oxidizing zone 212. The first portion of the fuel from 208 is delivered through a number of burner ports such as port 214 and through ports in the oxidation zone such as port 216. Another portion of the low-heat value fuel 206 is delivered through conduit 218 to a juncture where it is combined with a high-heating value fuel delivered by conduit 220 to form a burner feed that is carried by burner feed line 222 to a central burner nozzle 224 (note: while only one nozzle224 is shown, in other embodiments more mass can be introduced by using a multiple nozzle design). The high-heating value fuel may also be delivered by conduit 226 for use in the various ports during the start-up mode. During operation in the start-up mode, it may be desirable to adjust the energy density with steam. Steam is provided through line 228. In such a case, the steam, which is supplied to an ring around the burner nozzle 224, is provided to dilute the high-heating value fuel delivered through conduit 226 during the start-up mode. Otherwise, the steam is fully delivered through conduit 230 to ring 232 and steam injection ports 234, which are located in expansion zone 236.

In operation this configuration allows for startup using a high-heating value fuel that is diluted as needed with steam until the combustor is up and running and eventually a low-heating-value fuel is provided through line 208 and the high-heating-value fuel of line 226 is reduced or terminated and the combustor continues to function with one or more nozzles 224 providing a primary flame within the combustion chamber 210. Additional reactions take place within an oxidation zone 212, which may further include a dilution zone 213, leading to an expansion zone 236. In the zone 236 (and to some extent zone 213 if steam is added upstream), the combustion products from zones 210 and 212 are mixed with steam to provide a mixed product that is delivered through conduit 240 to an expander. As suggested in connection with FIG. 4, a control loop can be established between the load carried by the expander and the steam supplied through conduit 228 to allow the speed of the shaft or the load carried by the expander to be maintained with constancy. Various alterations can be made to the combustor of turbine portion 200 to allow it to burn a low-heating-value fuel while also allowing for the accommodation of massive amounts of steam to be added to the mass flow prior to its arrival at the expander.

This gas turbine of present invention is particularly useful in an application with a Fischer-Tropsch based hydrocarbon conversion system. In implementing such a system, the capital cost is a constant consideration. The incorporation of a turbine into such a system offers a number of advantages. In this regard, it is desirable to burn the resultant tail gas from such a system in the turbine, while doing so with a standard combustor that has been modified-not one built from scratch. The present invention does that and allows a standard gas turbine to be modified to extract compressed air for use in the hydrocarbon conversion system.

The hydrocarbon conversion system can be used to generate a low-heating-value tail gas that is supplied to the gas turbine combustor for use therein. The combustor is modified to burn the low-heating-value tail gas. To burn the fuel requires significant mass flow increases-on the order of a 60% increase or more. By staging the combustion in the combustor, it helps handle the additional mass. The front part uses a high- or medium-heating-value (relatively) fuel that provides a stable flame for the burner that acts like a pilot for the big mass flow that essentially flamelessly oxidizes (it will not sustain combustion on its own) downstream from the burner in the oxidation zone. This approach provides a wider range of operation of mass flows. But, the modified low-heating-value combustor alone would result in a turbine that is substantially de-rated from initial capacity.

By further modifying the gas turbine to receive additional mass in the form of steam, the turbine will be closer to the original rated power output. In running such a system, the tail gas used as fuel may go through variations that if unchecked might make the system unstable, but the present invention offers a solution in providing a control feed back that responds on the steam side of the system. The steam can be controlled to essentially be a fast throttle to hold the power output or speed of the turbine constant.

The invention also provides a convenient way to dispose of water. The tail gas generated by the hydocarbon conversion system may be stripped of contaminants with a water wash. The resultant water and process water from the hydrocarbon conversion system may be stripped with a tail gas. The resultant moisture in the tail gas can just be placed in the combustor as part of the low-heating-value fuel delivered to the oxidation zone. Further, the contaminants might be burned as part of the steam added to the low-heating-value fuel (e.g., added to line 149 of FIG. 4).

Although the present invention and its advantages have been described in detail, it should be understood that various changes, substitutions and alterations can be made therein without departing from the spirit and scope of invention as defined by the appended claims.

What is claimed is:

1. A process for operating a turbine having a combustor with a mixing zone, a flame zone, oxidation zone, and an expansion, the process comprising the steps of:
dividing a low-heating-value fuel gas feed into a burner portion and a combustion chamber portion;
conveying said combustion chamber portion and a combustion air into a mixing zone to form an air/fuel mixture;
conveying said burner portion into a flame zone through a burner nozzle while conveying a first portion of said air/fuel mixture into said flame zone through a burner port;
contacting said burner portion and said first portion of said air/fuel mixture in said flame zone to combust said burner portion and said first portion and produce flame zone products;
conveying said flame zone products into the oxidation zone downstream of said flame zone while conveying a second portion of said air/fuel mixture into said oxidation zone and reacting said second portion in said oxidation zone in the presence of said flame zone products to produce combustion products;
introducing superheated steam in the expansion zone where it is mixed with the combustion products;
conveying said combustion products and steam into a gas turbine expander to drive said gas turbine to rotate a shaft to carry a load.

2. The process of claim 1 further comprising the steps of monitoring speed of said shaft to produce speed measurement; providing a control valve that receives a control signal; and providing a controller that receives said speed measurement and responsively produces said control signal to maintain a desired constant speed.

3. The process of claim 1 further comprising the steps of monitoring the load of said shaft to produce a load measurement; providing a control valve that receives a control signal; and providing a controller that receives said speed measurement and responsively produces said control signal to maintain a desired constant load.

4. A process for manufacturing a low-heating-value gas turbine comprising the steps of:
providing a gas turbine;
modifying the combustor of said gas turbine to operate on a low heating-value fuel; and
providing a steam injection means for injecting steam downstream of a flame zone of the combustor.

5. A hydrocarbon conversion process that uses a gas turbine, the process comprises the steps of:
preparing a synthesis gas;
converting the synthesis gas to Fischer-Tropsch products and a low-heating-value tail gas;
delivering the tail gas to the gas turbine;
using the tail gas in the gas turbine;
using at least some compressed air from the gas turbine in the step of preparing synthesis gas;
generating steam; and
injecting the steam into the gas turbine to assist in the production of power.

6. The process of claim 5 further including the step of monitoring the power output of the gas turbine and regulating it by controlling the steam injected into the gas turbine.

7. All the inventions explicitly and implicitly presented herein.
